(19) United States
(12) Patent Application Publication
(10) Pub. No.: US 2016/0216931 A1
(43) Pub. Date: Jul. 28, 2016

(54) MOBILE DEVICE DETACHABLE DISPLAY SCREEN ACCESSORY

(71) Applicant: Kobo Incorporated, Toronto (CA)

(72) Inventor: Juan Ernesto Salas IMANA, Toronto (CA)

(73) Assignee: KOBO INCORPORATED, Toronto (CA)

(21) Appl. No.: 14/607,453

(22) Filed: Jan. 28, 2015

(51) Int. Cl. G06F 3/14; G09G 5/00; G06F 3/041

(52) U.S. Cl. CPC G06F 3/1423; G06F 3/0416; G09G 5/003; G09G 2330/021; G09G 2380/14

(57) ABSTRACT

A method and system for operating a mobile device detachable accessory display screen. The method comprises receiving a request to electrically couple a detachable accessory at the computing device, the detachable accessory including a secondary display screen, monitoring for a display screen transition event, transitioning operation of the computing device to the secondary display screen upon detecting the display screen transition event, and rendering the digital content item for reading on the secondary display screen of the detachable accessory.

### TECHNICAL FIELD

Examples described herein relate to a system and method for operating a computing device with a detachable accessory display screen.

### BACKGROUND

An electronic personal display is a mobile computing device that displays information to a user. While an electronic personal display may be capable of many of the functions of a personal computer, a user can typically interact directly with an electronic personal display without the use of a keyboard that is separate from, or coupled to, but distinct from the electronic personal display itself. Some examples of electronic personal displays include mobile digital devices/tablet computers and electronic readers (e-readers) such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, Kobo Aura H2O, Kobo GLO and the like).

Some electronic personal display devices are purpose built devices designed to perform especially well at displaying digitally stored content for reading or viewing thereon. For example, a purpose build device may include a display that reduces glare, performs well in high lighting conditions, and/or mimics the look of text as presented via actual discrete pages of paper. While such purpose built devices may excel at displaying content for a user to read, they may also perform other functions, such as displaying images, emitting audio, recording audio, and web surfing, among others.

Electronic personal display devices are among numerous kinds of consumer devices that can receive services and utilize resources across a network service. Such devices can operate applications or provide other functionality that links a device to a particular account of a specific service. For example, the electronic reader (e-reader) devices typically link to an online bookstore, and media playback devices often include applications that enable the user to access an online media electronic library (or e-library). In this context, the user accounts can enable the user to receive the full benefit and functionality of the device.

Yet further, such devices may incorporate a touch screen display having integrated touch sensors and touch sensing functionality, whereby user input commands via touch-based gestures are received thereon.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1A illustrates an e-reading device configured for operation in conjunction with a detachable accessory display screen, according to an embodiment.

FIG. 1B illustrates an attachable/detachable device accessory cover that includes a secondary display screen, according to an embodiment.

FIG. 2 illustrates a schematic architecture of a mobile computing device, such as a tablet or e-reader, configured for operation in conjunction with a detachable accessory display screen, according to an embodiment.

FIG. 3 is a block diagram of a method for transitioning operation of a touch screen display of an e-reading device to secondary display screen depending on detection of a screen transition event being triggered.

### DETAILED DESCRIPTION

“E-books” are a form of electronic publication content stored in digital format in a computer non-transitory memory, viewable on a computing device having display functionality. An e-book can correspond to, or mimic, the paginated format of a printed publication for viewing, such as provided by printed literary works (e.g., novels) and periodicals (e.g., magazines, comic books, journals, etc.). Optionally, some e-books may have chapter designations, as well as content that corresponds to graphics or images (e.g., such as in the case of magazines or comic books). Multi-function devices, such as cellular-telephony or messaging devices, can utilize specialized applications (e.g., specialized e-reading application software) to view e-books in a format that mimics the paginated printed publication. Still further, some devices (sometimes labeled as “e-readers”) can display digitally-stored content in a more reading-centric manner, while also providing, via a user input interface, the ability to manipulate that content for viewing, such as via discrete pages arranged sequentially (that is, pagination) corresponding to an intended or natural reading progression, or flow, of the content therein. The term e-book as used herein is also intended to encompass an e-magazine or an e-comic book, wherein each of the digitally constructed pages includes several distinctive panels or frames of text and/or images, and reading progression within a page may include navigating in sequential steps from one such panel or frame to another within a same page.

An “e-reading device”, variously referred to herein as an electronic personal display or mobile computing device, can refer to any computing device that can display or otherwise render an e-book. By way of example, an e-reading device can include a mobile computing device on which an e-reading application can be executed to render content that includes e-books (e.g., comic books, magazines, etc.). Such mobile computing devices can include, for example, a multi-functional computing device for cellular telephony/messaging (e.g., feature phone or smart phone), a tablet computer device, an ultra-mobile computing device, or a wearable computing device with a form factor of a wearable accessory device (e.g., smart watch or bracelet, glass-wear integrated with a computing device, etc.). As another example, an e-reading device can include an e-reader device, such as a purpose-built device that is optimized for an e-reading experience (e.g., with e-Ink displays).

While engaged in an immersive e-reading experience, a combination of factors such as ambient lighting brightness, reflection and glare from the display screen while viewing displayed content may significantly affect reading comfort and enjoyment of the user's reading experience. A user should ideally be able to read comfortably for extended periods of time on the device display screen, to provide a digital reading experience that is comparable to the natural convenience of reading a physical paper book. It would be further preferable that a display screen consume relatively minimal device battery power, to enable reading for lengthy, immersive periods without having to recharge the device battery.

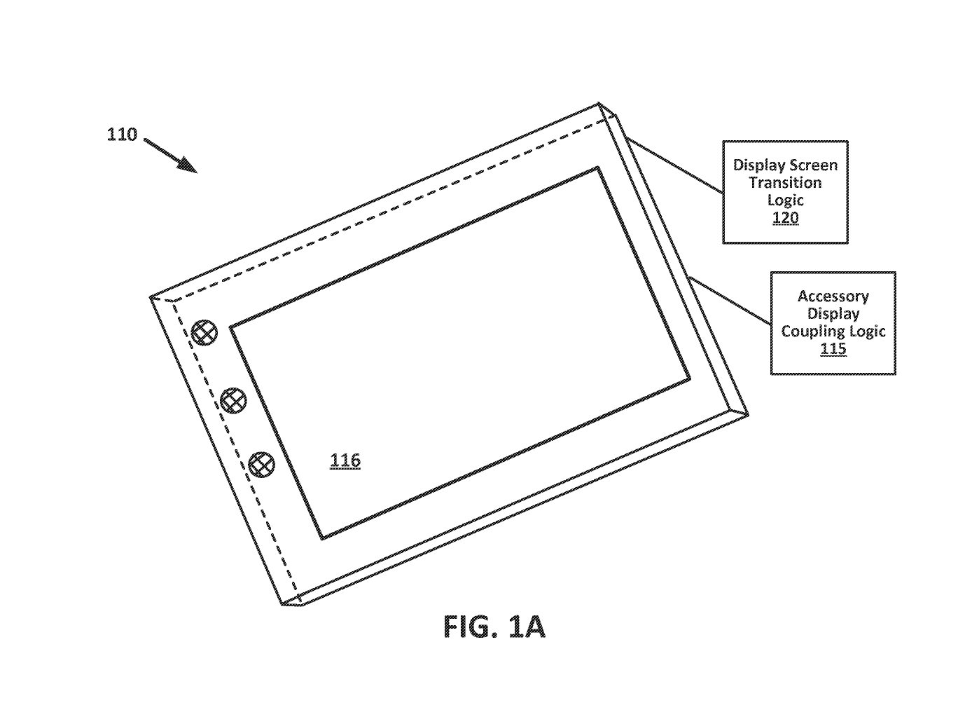

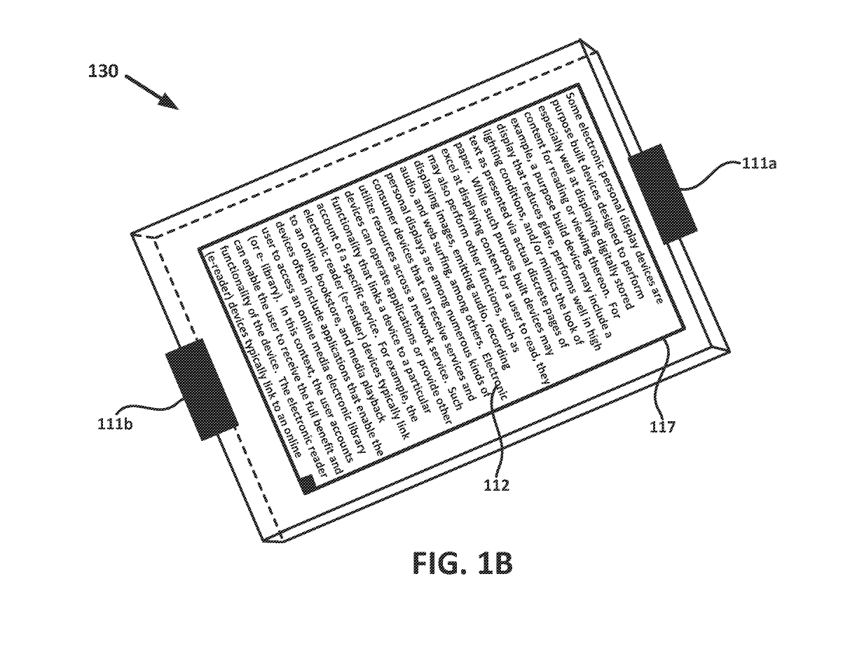

FIG. 1A illustrates an e-reading device 110, in one embodiment configured for operation of a primary display screen 116 and having means for electrically coupling to an attachable/detachable accessory device. In the example of FIG. 1, e-reading device 110 comprises an electronic personal display device, shown by way of example as e-reading device 110. The terms e-reading device, computing device and electronic personal display device are used interchangeably herein. In some implementations, primary display screen 116 can correspond to, for example, a liquid crystal display (LCD) or light emitting diode (LED) display that illuminates in order to display content thereon. In some implementations, display 116 can be touch-sensitive. For example, in some embodiments, one or more of the touch sensor components may be integrated with display 116. In other embodiments, the touch sensor components may be provided (e.g., as a layer) above or below display 116 such that individual touch sensor components track different regions of display 116.

FIG. 1B illustrates an embodiment of attachable/detachable device accessory cover 130 that includes a secondary display screen 117. In an embodiment, secondary display screen 117 can correspond to an electronic paper type display, such as an e-ink or bi-stable display that mimic conventional paper in the manner in which content is displayed. Typically, e-ink displays are more suited to e-reading under extreme ambient lighting conditions, such as very bright daylight or in near-darkness at bedtime, for long, immersive periods, resulting is less eye strain as compared to reading, for example, on an LCD display screen. Examples of such electronic paper display technologies include electrophoretic displays, electro-wetting displays, and electro-fluidic displays. Secondary display screen 117 can also be touch-sensitive; for example, in some embodiments, one or more of the touch sensor components may be integrated with display 117, providing touch screen capability. Yet further, c-ink displays embodied in secondary display screen 117 consume relatively very minimal device battery power in comparison with, for example, an LCD display used in primary display screen 116. In some cases, e-ink displays consume computing device battery power at a less than 10 percent rate as compared to consumption of an LCD primary screen. For yet this additional reason, an e-ink screen as embodied in secondary display screen 117 would be very desirable for lengthy, immersive periods of reading e-book content via e-reading device 110.

In the embodiment of attachable/detachable device accessory cover 130 depicted in FIG. 1B, provided are retention and registration clips 111a, 111b to retain securely accessory cover 130 onto e-reading device 110. Retention clips 111a, 111b may further provide a mechanical connector apparatus of accessory cover 130 in accurate and fixed registration with a counterpart mating connector apparatus counterpart of e-reading device 110. In an embodiment, such a mechanical connector means may enable a mechanical and as well as electrical connection between accessory cover 130 and e-reading device 110. The electrical connection scheme may provide a data transfer and communications capability, whereby, upon interconnecting detachable device accessory cover 130 and e-reading device 110, a processor of computing device may control functionality and functioning of secondary display screen 117, for example at least with regard to e-book page transition actions performed at a touchscreen embodiment of secondary display screen 117. Yet further, the interconnection may provide a power transfer path whereby detachable device accessory cover 130 may operate by using power sourced from a battery component of e-reading device 110. In another embodiment, detachable device accessory cover 130 may include an independent, rechargeable power source or battery.

In embodiments, accessory cover 130 including display screen 117 may be disposed on a rear housing face of e-reading device 110, or oppositely located over the front housing face that includes primary display screen 116. Other configurations are contemplated, such as whereby accessory cover 130 including display screen 117 may be attachable along a longitudinal edge of e-reading device 110, being pivotal about such edge into one of: an opened position side-by-side with primary display screen 116, and a closed position superimposed over primary display screen 116.

The e-reading device 110 can correspond to any electronic personal display device on which applications and application resources (e.g., e-books, media files, documents) can be rendered and consumed. For example, the e-reading device 110 can correspond to a tablet or a telephony/messaging device (e.g., smart phone). In one implementation, for example, e-reading device 110 can run an e-reader application that links the device to a network service and enables e-books provided through the service to be downloaded and stored, for consumption by way of e-reading. In another implementation, the e-reading device 110 can run a media playback or streaming application that receives files or streaming data from the network service. By way of example, the e-reading device 110 can be equipped with hardware and software to optimize certain application activities, such as reading electronic content (e.g., e-books). For example, the e-reading device 110 can have a tablet-like form factor, although variations are possible. In some cases, primary display screen 116 of e-reading device 110 may be a liquid crystal display and display screen 117 may be an e-ink display or bi-stable display.

In additional detail, such a network service can include a content store server and a user account electronic library (e-library) storing e-books or digital content items. In some embodiments, the content store server and user account e-library may be implemented via server computing devices, as well as a server cloud computing system. The content store server may be an on-line store for purchasing of digital content items for download therefrom onto a resident memory of e-reading device 110 and/or the user account e-library which associates the e-reading device 110 with a user having an account. The user account can also be associated with ownership of, and/or accessibility to, one or more e-books and digital content items stored in content store server.

Yet further, the content store server and user account e-library can retain metadata associated with e-books or other digital content items that have been purchased or made available for consumption via a user's e-library. Thus, information relating to each of the e-books within a user account e-library can include a metadata set in addition to substantive digital text and image content portions. The metadata set can include, for example, information such as the graphic representation of the e-book, such as including artwork- or image-based representation of a counterpart physical paper book cover, as well as summary information, author information, title, short synapse or book review, publication date and language of the e-book, and book or volume series information.

The e-reading device 110 may include accessory display coupling logic module 115 for detecting establishment of an electrical connection between accessory cover 130 and e-reading device 110, such as by interconnection via mechanical/electrical connection.

Display screen transition logic module 120 provides capability, in an embodiment, for activation and transitioning of operation from touchscreen display 116 of e-reading device 110 to attachable secondary display screen 117, upon detection of a screen transition event. In an embodiment, the screen transition event may be detected in conjunction with accessory display coupling logic 115 as triggered by establishment of an electrical connection between accessory cover 130 and e-reading device 110, such as by interconnection via mechanical/electrical connection, whereupon the display screen that is transitioned to will be used automatically at e-reading device 110 to display the e-book content.

Display screen transition logic module 120 and accessory display coupling logic module 115 can be implemented as software modules comprising instructions stored in a memory of a computing device such as the content store server and/or e-reading device 110. One or more embodiments of display screen transition logic module 120 and/or accessory display coupling logic module 115 described herein may be implemented using programmatic modules or components. A programmatic module or component may include a program, a subroutine, a portion of a program, or software or a hardware component capable of performing one or more stated tasks or functions in conjunction with one or more processors. As used herein, a module or component can exist on a hardware component independently of other modules or components. Alternatively, a module or component can be a shared element or process of other modules, programs and hardware components.

Furthermore, the one or more embodiments of display screen transition logic module 120 and accessory display coupling logic module 115 described herein may be implemented through instructions that are executable by one or more processors. These instructions may be stored on a computer-readable non-transitory medium. In particular, the numerous computing and communication devices shown with embodiments of the invention include processor(s) and various forms of computer memory, including volatile and non-volatile forms, storing data and instructions. Examples of computer-readable mediums include permanent memory storage devices, such as hard drives on personal computers or servers. Other examples of computer storage mediums include portable storage units, flash or solid-state memory (such as included on many cell phones and consumer electronic devices) and magnetic memory. Computers, terminals, network enabled devices (e.g., mobile devices such as cell phones and wearable computers) are all examples of machines and devices that utilize processors, memory, and instructions stored on computer-readable mediums. Additionally, embodiments may be implemented in the form of computer-programs, or a computer usable storage medium capable of storing such a program.

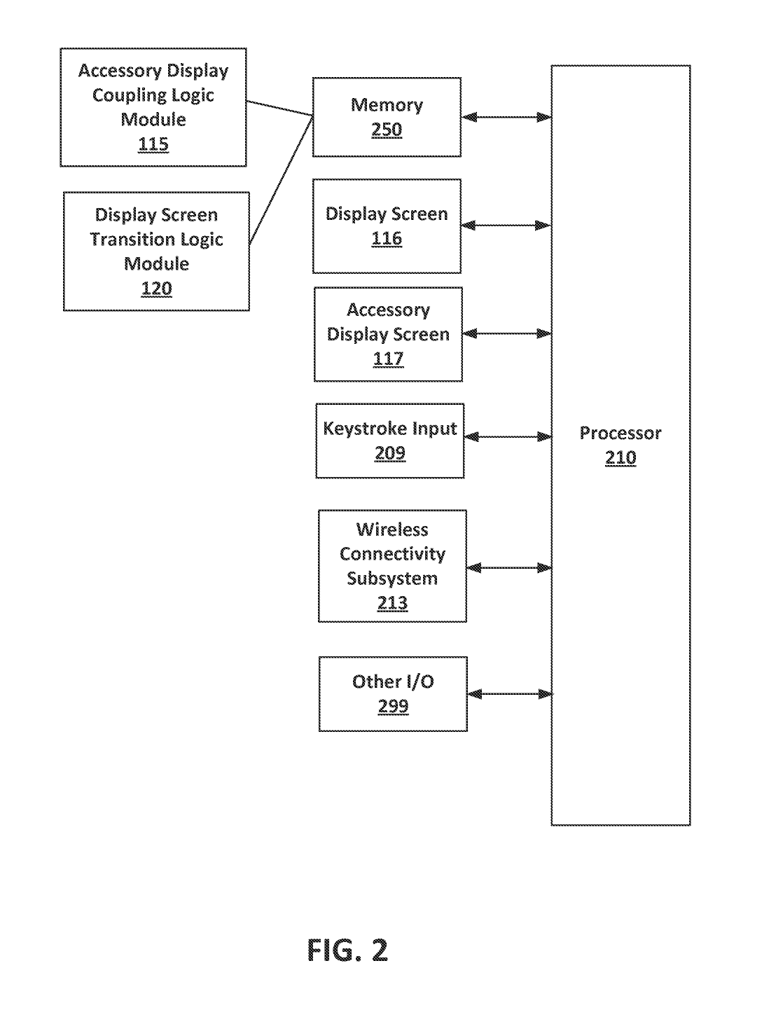

With reference now to FIG. 2, illustrated is a schematic architecture of a mobile computing device, such as a tablet or e-reader, configured for operation in conjunction with a detachable accessory display screen.

E-reading device 110 further includes processor 210, a memory 250 storing instructions and logic pertaining at least to display sensor logic, display screen transition logic module 120 and accessory display coupling logic module 115.

Processor 210 can implement functionality using the logic and instructions stored in memory 250. Additionally, in some implementations, processor 210 communicates with the network service. More specifically, the e-reading device 110 can access the network service to receive various kinds of resources, e.g., digital content items including e-books, digital videos, as well as configuration files and account information, as well as to provide information (e.g., user account information, service requests etc.). For example, e-reading device 110 can receive application resources, including digital content items such as e-books or media files that the user elects to purchase or otherwise download via the network service. The application resources, including e-books having content organized as a series of digitally constructed pages, that are downloaded onto the e-reading device 110 can be stored in memory 250.

Processor 210 can receive input from various sources, including touch sensor components at displays 116, 117, keystroke input 209 such as from a virtual or rendered keyboard, and other input mechanisms 299 (e.g., buttons, mouse, microphone, etc.). With reference to examples described herein, processor 210 can respond to input detected at the touch sensor components. In some embodiments, processor 210 responds to inputs from the touch sensor components in order to facilitate or enhance e-book activities such as generating e-book content on displays 116, 117, performing page transitions of the displayed e-book content, powering off the e-reading device 110 and/or displays 116, 117, activating a screen saver, launching or closing an application, and/or otherwise altering a state of displays 116, 117.

Still with reference to FIG. 2 in conjunction with FIGS. 1A, 1B, display screens 116, 117 may be touch-sensitive, to process touch inputs including gestures, e.g., a swipe gesture comprising a sustained touch while moving along a particular direction upon the touchscreen surface). For example, display screens 116, 117 may be integrated with one or more touch sensors to provide a touch-sensing region on their respective display surfaces. For some embodiments, the one or more touch sensors may include capacitive sensors that can sense or detect a human body's capacitance as input. In the examples of FIG. 1, the touch-sensing region coincides with a substantial surface area, if not all, of the display screens 116, 117.

According to some embodiments, the e-reading device 110 includes display sensor logic to detect and interpret user input or user input commands made through interaction with the touch sensors of display screens 116, 117. By way of example, display sensor logic can detect a user making contact with the touch-sensing region of the display screens 116, 117, otherwise referred to herein as a touch event. More specifically, display sensor logic can detect a touch event also referred to herein as a tap, an initial tap held in contact at display screens 116, 117 for longer than some pre-defined threshold duration of time (otherwise known as a “long press” or a “long touch”), multiple taps performed either sequentially or generally simultaneously, swiping gesture actions made through user interaction with the touch sensing region of the display screens 116, 117 or any combination of these gesture actions. Although referred to herein as a “touch” or a tap, it should be appreciated that in some design implementations, sufficient proximity to the screen surface, just short of actual physical contact, may register a “contact” or a “touch event”. Furthermore, display sensor logic can interpret such interactions in a variety of ways. For example, each such interaction may be interpreted as a particular type of user input associated with a respective input command, execution of which may trigger a change in state at touchscreen displays 116, 117.

The touch screen display sensor capability may be applied by the user to transition through paginated content. The e-reading device 110 can display pages from e-books, and enable the user to transition from one page state to another, including advancing forward or backward within the pages of e-book content. In particular, an e-book can provide content that is rendered according to a sequence of digitally constructed pages, and the e-book can display page states in the form of single pages, multiple pages or portions thereof. In alternate embodiments, the e-book may be an e-magazine or an e-comic book, wherein each of the digitally constructed pages includes several distinctive panels or frames of text and/or images, and reading progression within a page may include navigating in sequential steps from one such panel or frame to another within a same page. Accordingly, a given page state can coincide with, for example, a single page, or two or more pages displayed at once, and in some implementations, the page transitioning feature may include single page transitions, chapter transitions, or cluster transitions (multiple pages at one time) within the sequence of digitally constructed pages comprising the e-book.

In embodiments, memory 250 may store display sensor logic that monitors for user interactions detected through the touch sensor components, and further processes the user interactions as a particular input or type of input. In an alternative embodiment, display sensor logic module may be integrated with the touch sensor components. For example, the touch sensor components can be provided as a modular component that includes integrated circuits or other hardware logic, and such resources can provide some or all of display sensor logic. In variations, some or all of display sensor logic may be implemented with processor 210 (which utilizes instructions stored in memory 250), or with an alternative processing resource.

Memory 250 also stores digital content items including e-books having respectively associated metadata records, each e-book having its unique metadata record in addition to the substantive content of the e-book, i.e., the digitally constructed paginated content for e-reading via the display screen of the e-reading device.

E-reading device 110 further includes wireless connectivity subsystem 213, comprising a wireless communication receiver, a transmitter, and associated components, such as one or more embedded or internal antenna elements, local oscillators, and a processing module such as a digital signal processor (DSP) (not shown). As will be apparent to those skilled in the field of communications, the particular design of wireless connectivity subsystem 213 depends on the communication network in which e-reading device 110 is intended to operate, such as in accordance with Wi-Fi, Bluetooth, Near Field Communication (NFC) communication protocols, and the like. In embodiments, attachable/detachable device accessory cover 130 may incorporate electronic circuitry and capability to enable data transfer communications between secondary display screen 117 and processor 210 of e-reading device. In such embodiments, whenever attachable/detachable device accessory cover 130 is coupled to e-reading device 110, establishment of the coupling may act as a trigger event whereby secondary display screen 117 is activated via processor 210, and operation is transitioned thereto. In other words, secondary display screen 117 now becomes controllable via processor 210 of e-reading device 110 in comparable manner and functionality (e.g., page transition actions can be enacted upon a surface of a touchscreen secondary display screen 117) as for primary display screen 116. In a further embodiment, functionality in displaying rendered e-book content 112 (see FIG. 1B) via secondary display screen 117, as transitioned from via primary display screen 116, upon detecting a screen transition event such as establishing of an electrical connection between detachable accessory cover 130 and processor 210 of e-reading device 110.

Display screen transition logic module 120 can be implemented as a software module, comprising instructions stored in memory 250, on mobile c-reading device 110. In one implementation, the local memory 250 can include records for each e-book in the user's e-library account. The user may have the content portion of select e-books archived remotely at a computer server cloud system, so as not to reside in the local memory 250, but be provided by the network service upon request or as needed.

Accessory display coupling logic module 115 operates in conjunction with display screen transition logic module 120 to activate secondary display screen 117 after detection of a display screen transition event.

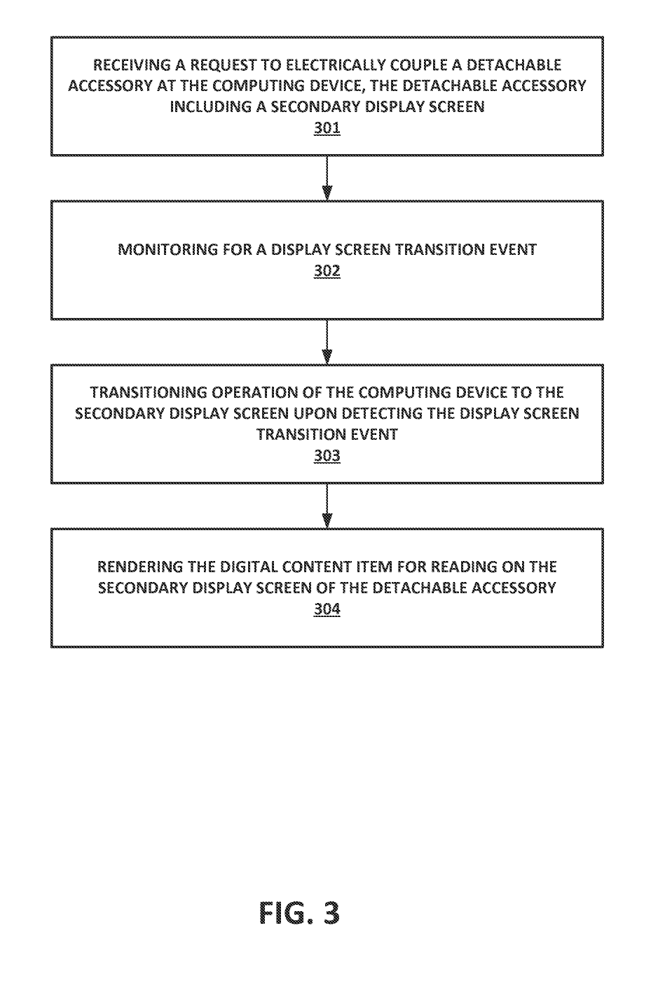

Next with reference to FIG. 3, a method is illustrated for transitioning operation of touch screen display 116 of e-reading device 110 to secondary display screen 117 depending on detection of a screen transition event being triggered, according to an embodiment. In describing the example of FIG. 3, reference will be made to components such as described with regard to FIGS. 1A, 1B and 2 for purposes of illustrating components for performing a step or sub-step as described.

At step 301, receiving a request to electrically couple a detachable accessory cover 130 at the e-reading device 110, the detachable accessory cover 130 including a secondary display screen 117. In an embodiment, secondary display screen 117, which may be an e-ink display screen, has a significantly lower power consumption rate than primary display screen 116 of e-reading device 110 which may be an LCD or LED display screen, thus allowing a user to engage in lengthy, immersive periods of e-reading, such as for e-books, without having to interrupt the reading experience to re-charge e-reading device 110. It is contemplated, in an embodiment, that the step of receiving the request may not need to be an explicit request, but such request may be implied by way of the act of a user in electrically and/or mechanically connecting accessory cover 130 to e-reading device 110.

At step 302, monitoring for a display screen transition event. The display screen transition event may be triggered upon electrical coupling of accessory cover 130 to e-reading device 110. The electrical coupling means may be wireless, such as enabling wireless data transfer to and from the e-reading device 110 and secondary display screen 117 of attachable/detachable accessory cover 130. In another embodiment, the display screen transition event may be a manual switch request to transition e-reading device 110 for operation via secondary display screen 117. Once interconnected, the interconnection may provide a power transfer path whereby detachable device accessory cover 130 may operate by using power sourced from a battery component of e-reading device 110. In another embodiment, detachable device accessory cover 130 may include an independent, rechargeable power source or battery.

At step 303, transitioning operation of the e-reading device 110 to the secondary display screen 117 upon detecting the display screen transition event. Optionally, upon transitioning operation of e-reading device 110 for e-reading of e-book content on secondary display screen 117, primary display screen 116 may be de-activated into a lower power mode, such as a sleep mode or power-off mode, for power conservation benefits, at least while rendering the e-book content 112 via secondary display screen 117.

At step 304, rendering the e-book content 112 for reading on the secondary display screen 117 of the detachable accessory cover 130. Upon such rendering, primary display screen 116 may be de-activated for attendant power conservation reasons, at least while secondary display screen 117 is in active operation for e-reading thereon.

Although illustrative embodiments have been described in detail herein with reference to the accompanying drawings, variations to specific embodiments and details are contemplated and encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method executed in a processor of a computing device, the computing device further including a primary touch screen display rendering a digital content item thereon, and a memory storing instructions, the method comprising:
receiving a request to electrically couple a detachable accessory at the computing device, the detachable accessory including a secondary display screen;
monitoring for a display screen transition event;
transitioning operation of the computing device to the secondary display screen upon detecting the display screen transition event; and
rendering the digital content item for reading on the secondary display screen of the detachable accessory.

2. The method of claim 1 wherein the primary touch screen displays s comprises a liquid crystal display (LCD) screen.

3. The method of claim 1 wherein the primary touch screen display comprises a light emitting diode (LED) screen.

4. The method of claim 1 wherein the secondary display screen is a bi-stable e-ink display screen.

5. The method of claim 4 wherein the secondary display screen comprises a touch screen.

6. The method of claim 1 further comprising de-activating the primary display screen for operation while rendering the digital content item for reading on the secondary display screen.

7. The method of claim 1 wherein the secondary display screen comprises a lower rate of device power consumption relative to the primary touch screen display.

8. The method of claim 1 wherein the display screen transition event comprises electrically coupling the detachable accessory to the computing device.

9. The method of claim 8 wherein the electrical coupling comprises a power transfer coupling.

10. The method of claim 8 wherein the electrical coupling comprises a data transfer coupling.

11. The method of claim 1 wherein the display screen transition event comprises a manual switch request to transition the computing device into operation via the secondary display screen.

12. A computing device comprising:
a memory that stores a set of instructions;
a primary touch screen displays rendering a digital content item; and
a processor that accesses the instructions in memory, the processor further configured to:
receive a request to electrically couple a detachable accessory at the computing device, the detachable accessory including a secondary display screen;
monitor for a display screen transition event;
transition operation of the computing device to the secondary display screen upon detecting the display screen transition event; and
render the digital content item for reading on the secondary display screen of the detachable accessory.

13. The computing device of claim 12 wherein the primary display screen comprises a liquid crystal display (LCD) screen.

14. The computing device of claim 12 wherein the secondary display screen is an e-ink display screen.

15. The computing device of claim 12 wherein the secondary display screen is a bi-stable display screen.

16. The computing device of claim 12 further comprising de-activating the primary display screen for operation while rendering the digital content item via the secondary display screen.

17. The computing device of claim 12 wherein the secondary display screen comprises a lower rate of device power consumption relative to the primary touch screen display.

18. The computing device of claim 12 wherein the display screen transition event comprises electrically coupling the detachable accessory to the computing device.

19. The computing device of claim 18 wherein the electrical coupling comprises a power transfer coupling.

20. The computing device of claim 18 wherein the electrical coupling comprises a data transfer coupling.
